(19) United States
(12) Patent Application Publication
(10) Pub. No.: US 2024/0224329 A1
(43) Pub. Date: Jul. 4, 2024

(54) PROTOCOL AT THE 802.11 MEDIUM ACCESS CONTROL LAYER FOR EXPLOITING MULTIPLE PACKET RECEPTION CAPABILITY BASED ON MULTIPLE ROUNDS OF TRANSMISSION AND CONTENTION

(71) Applicant: CENTRO DE INVESTIGACIÓN Y DE ESTUDIOS AVANZADOS DEL INSTITUTO POLITECNICO NACIONAL, Zapopan (MX)

(72) Inventors: Victor SANDOVAL CURMINA, Mérida (MX); Ramon PARRA MICHEL, Zapopan (MX); Aldo Gustavo OROZCO LUGO, Gustavo A. Madero (MX); Manuel Mauricio LARA BARRON, Gustavo A. Madero (MX)

(73) Assignee: CENTRO DE INVESTIGACIÓN Y DE ESTUDIOS AVANZADOS DEL INSTITUTO POLITECNICO NACIONAL, Zapopan (MX)

(21) Appl. No.: 18/539,524

(22) Filed: Dec. 14, 2023

(30) Foreign Application Priority Data
Dec. 14, 2022 (MX) 2022/016137

(51) Int. Cl. H04W 74/08

(52) U.S. Cl. CPC H04W 74/0816; H04W 84/12

(57) ABSTRACT

The present invention proposes a protocol based on multiple transmission and contention rounds that schedules several transmission rounds after the contention phase is completed. The multiple transmission rounds reduce the sending of control packets and substantially increase the cross traffic on the uplink to the AP. The supporting analytical expressions for determining the traffic carried of the proposed protocol demonstrate through simulation that about 94% of the ideal throughput of available throughput can be achieved by using as few as four transmission rounds during the transmission period.

### CROSS-REFERENCE TO RELATED APPLICATIONS

The present application claims priority to Mexican Patent Application No. MX/a/2022/016137, filed with the Mexico Patent Office on Dec. 14, 2022, the disclosure of which is hereby incorporated herein by reference in its entirety.

### FIELD OF THE INVENTION

This invention presents a new MAC protocol based on the IEEE 802.11 standard by taking advantage of the MPR capability during the contention period to distinguish the largest number of active stations with data packets to be sent and a modification in the handling and interpretation of the information provided by the CTS packet in order to generate multiple transmission rounds with the data packets that the stations have to send and reduce the ratio between the contention period and the transmission period.

### BACKGROUND OF THE INVENTION

The IEEE (Institute of Electrical and Electronics Engineers) 802.11 standard is widely used in wireless local area network (WLAN) environments. This standard uses the Carrier Sense Multiple Access with Collision Avoidance (CSMA/CA) protocol at the Media Access Control (MAC) layer, and various amendments have retained this operating mechanism. In contrast, changes to the IEEE 802.11 physical layer have significantly modified the modulation and signal processing techniques to handle different qualities of service (QoS), allowing wireless receivers to separate multiple packets that were received simultaneously; this capability is known as Multi-Packet Reception (MPR). The necessary modifications to the operation of the CSMA/CA protocol at the MAC layer of the IEEE 802.11 standard that operate on physical layers with MPR capability.

F. Gebali in his paper “Modeling IEEE 802.11 (WiFi) Protocol,” in Analysis of Computer Networks; conducted initial studies on the CSMA/CA protocol maintaining the RTS/CTS (Request-To-Send/Clear-To-Send) access mechanism used in IEEE 802.11 networks, but considering the handling of the MPR capability through a small change in the standard. This consisted of increasing the number of Receiver Address (RA) fields in CTS and ACK (Acknowledgment) packets to a number equal to the receiver's MPR capability. Later, Y. J. A. Zhang in his paper “Multi-round contention in wireless LANs with multipacket reception,” IEEE Transactions on Wireless Communications; extended the presented Gebali model and proposed a new method called Multi-round contention random access protocol. In this proposal, the stations (STA) continue to send RTS packets in the contention period until the AP (Access Point) has received a number M of packets equal or close to the MPR capacity. The key contribution of multiple contention rounds is to use the optimal stopping theory to determine the optimal time to stop the contention period. Zhang's protocol can guarantee full utilization of the MPR capacity in the channel during the transmission period, achieving significant improvement in network throughput.

### SUMMARY OF THE INVENTION

The objective of this patent is to provide anew MAC protocol with modifications to the CSMA/CA with RTS/CTS mechanism used in the IEEE 802.11 standard by adding the use and interpretation of the information provided by the CTS packet to generate multiple rounds of transmission of the data packets (Data, DATA) sent by the STAs and further exploit the capability of MPR in extending both the contention period and the transmission period, this protocol is known as Multi-Round Transmission and Contention (MRTC). Three main contributions are provided to achieve the proposed objective. The first contribution is aimed at better utilization of the MPR capacity provided by the physical layer of the AP due to the extension of the transmission period with a controlled increase of the contention period to distinguish a larger number of active STAs. The second contribution is associated with the reduction in the use of control packets by handling the CTS packet as a Negative Acknowledgment (NACK) for STAs that transmitted DATA packets in the previous round of transmission. The third contribution is to achieve a throughput in the WLAN traffic carried that approaches the ideal due to the fact that the transmission period starts to be much longer than the contention period when the optimal time to stop the contention period is properly chosen.

The changes to the IEEE 802.11 MAC protocol that are proposed to take advantage of the MPR capability are as follows:
1) Modify the CTS and ACK packet formats by increasing the number of RA fields in the CTS and ACK packets from one to the MPR capacity of the AP. This increase allows multiple DATA packet transmissions to be requested from stations through the sending of a CTS packet and confirms successful receptions of data packets through the sending of an ACK packet.
2) The AP decides whether or not to transmit a CTS packet after successfully receiving some RTS packets. The AP uses the optimal stopping rule to determine the optimal time to end the contention period by transmitting the CTS packet.
3) The CTS packets have a second function as NACK between transmission rounds of data packets within the transmission period. Here the AP, after the successful reception of the data packets and that the transmission period is not yet finished due to missing stations to transmit, transmits a CTS packet indicating which stations will transmit in the next transmission round and the stations that transmitted in the previous round not seeing their address then assume that their data packet was successfully received.

Summarizing, CTS packets perform two functions: to indicate which STAs will transmit in the next transmission round and to inform which STAs successfully transmitted in the last transmission round.

In this sense, the protocol based on multiple transmission rounds and contention schedules several transmission rounds after the contention phase is over. The multiple transmission rounds reduce the sending of control packets and substantially increase the traffic carried on the uplink to the AP. The supporting analytical expressions for determining the traffic carried of the proposed protocol demonstrate through simulation that about 94% of the ideal throughput of available traffic carried can be achieved by using as few as four transmission rounds during the transmission period.

### BRIEF DESCRIPTION OF THE FIGURES

FIG. 1 represents the operation of the MRTC protocol, which is the subject of this patent. The operation period is divided into renewal intervals (101), where the renewal interval is formed by a contention period (102) and a transmission period (103). The contention period is divided into contention rounds (104) and the transmission period is divided into transmission rounds (105). The control packets are RTS (106), CTS (107) and ACK (108); and the DATA packets (109) are only sent in the transmission period.

FIG. 2 shows the information fields carried by the control packets used by the CSMA/CA protocol with RTS/CTS mechanism. The packets are: RTS (201), which remains unchanged with respect to the original protocol of the IEEE 802.11 standard, CTS (202) and ACK (203) which are modified.

FIG. 3 shows the basic operation of the CSMA/CA protocol with RTS/CTS mechanism established in the IEEE 802.11 standard for the MAC layer. Here we can see the functions of the RTS, CTS and ACK control packets for an STA to transmit a DATA packet.

FIG. 4 shows the analytical and simulated results on the S_{avg} with the MRTC protocol and the “Zhang” method when increasing the threshold for stopping for an MPR capacity equal to 10, traffic offered that maximizes the expected value of RTS packets received by the AP in a contention round equal to 7.287 and a data length equal to 8184 bits at a transmission rate of 54 Mbps.

FIG. 5 illustrates the behavior of the traffic carried S_{avg} with respect to the traffic offered λ of MRTC protocol and the proposed methods. Here we work with an MPR capacity equal to 10, a data length equal to 8184 bits at a transmission rate of 54 Mbps. In all cases we use the θ* which is the threshold for optimal stopping, and only for the “Zheng” method θ*=1.

### DETAILED DESCRIPTION OF THE INVENTION

In the following, various aspects of the invention will be described in greater detail in connection with a number of exemplary embodiments.

To facilitate a better understanding of the invention, various components of the invention are described in terms of sequences of actions to be performed by elements in a plurality of communication devices.

In each of the embodiments presented, the various actions could be performed by specialized circuits, by one or more processors, by a wireless communication system, or by a combination of both.

We generally refer to such an element as a node, a transmitter, a media access control (MAC) or an access point.

An appropriate subset of these components and embodiments may optionally be employed and combined with other components/realizations to realize the objectives and achieve the respective advantages for the protocol at the 802.11 medium access control layer for leveraging multiple packet reception capability based on multiple rounds of transmission and contention.

In addition, different nodes may use different combinations due to their constraints, available resources, preferences, current status and the respective environmental conditions where they are located.

As a result, the various aspects of the invention can be embodied in many different forms, and it is contemplated that all of these forms will be within the scope of the invention.

The MRTC protocol is similar to the operation of the CSMA/CA protocol with the RTS/CTS access mechanism in that it follows the steps illustrated in FIG. 3. After a DIFS period of the communication channel being free from the last ACK packet transmitted, the contention period begins, which ends after a SIFS period after a CTS packet has been transmitted by the AP in response to having received RTS packets. During the contention period is when a STA that has a DATA packet to transmit sends its RTS packet. The transmission period starts with the first transmission of DATA packets and ends after a DIFS period that the AP transmitted an ACK packet. STAs that successfully receive an RTS or CTS packet can have an estimate of the time that the channel will be allocated for the transmission of DATA packets through a mechanism known as Network Allocation Vector (NAV).

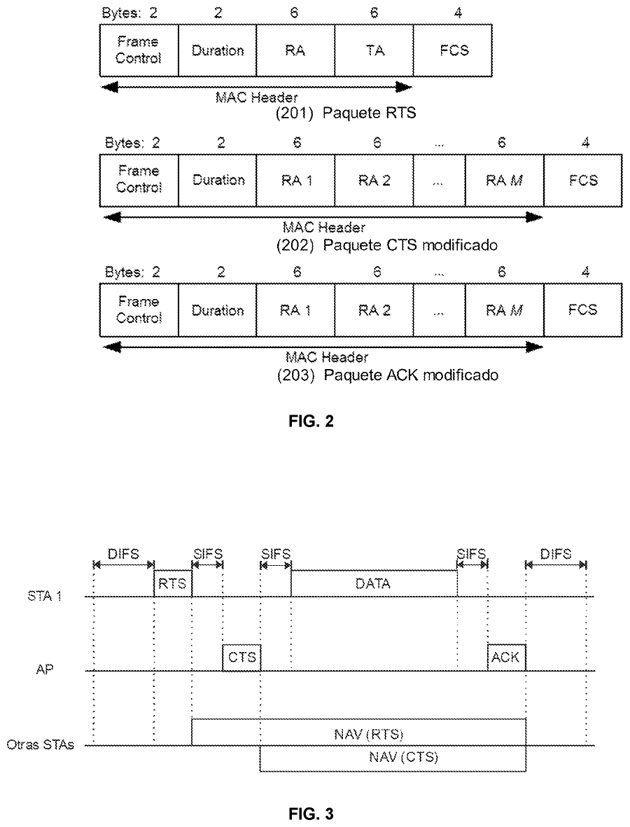

Regarding modifications to the CSMA/CA protocol with the RTS/CTS access mechanism, the following changes are proposed to take advantage of the MPR capability:
a) Vary the CTS (202) and ACK (203) packet formats by increasing the number of Receiver Address (RA) fields from one to a value M equal to the MPR capacity of the AP, as shown in FIG. 2. This increase allows requesting multiple transmissions of DATA packets to the STAs through the CTS packet and confirms successful receptions of DATA packets through the ACK packet. As for the RTS packet (201), it remains unchanged in its fields.
b) The AP decides whether or not to transmit a CTS packet after successfully receiving some RTS packets. The AP uses a rule to determine when to transmit the CTS packet and end the contention period. This rule is explained below.
c) CTS packets have a second function and it is as a NACK for STAs that have already sent DATA packets in a transmission round and are waiting for the AP to confirm them. This rule is also explained in detail below and is the second contribution made by the invention.

### A.—Description of the Operation for the MRTC Protocol.

To understand the operating rules established in the MRTC protocol, it is first necessary to know what are the key criteria used as a reference for its design. The criteria followed in the design are:
a) Choice of the length of the Contention Window (CW) based on the observations made during the periods of contention and the MPR capacity obtained from the channel.
b) Choice of the threshold θ as a rule for the optimal stopping of the contest period by the PA, thus establishing the trade-off between the total number of detected STAs and the duration of the contest period.
c) Minimal handling of control packages during the contest and transmission periods.

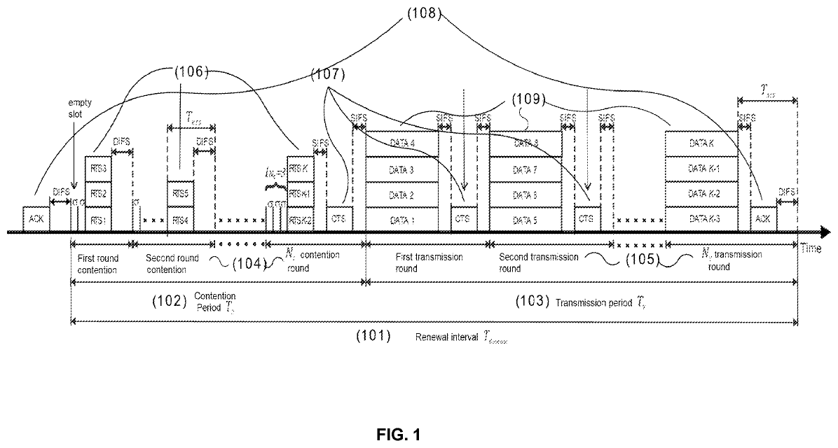

Once the main design criteria have been established, the detailed procedure to be followed by the MRTC protocol, as shown in FIG. 1, is as follows:
1. Channel time is divided into renewal intervals (101).
2. During the period of contention (102):
a) After a DIFS period of having received an ACK packet (108), each of the STAs randomly chooses a number of time slots between 0 and CW to transmit its RTS packet (106), as established by the IEEE 802.11 protocol standard, but with the exception that the CW value is taken from the last ACK packet (108) received. The AP also starts its time slot count, even if it does not have a DATA packet (109) to transmit using the CW value because it is in charge of ending the contention period when there is at least one RTS packet (106) transmitted for it.
(b) Multiple contention rounds are performed among all STAs as long as the AP does not send a CTS packet (107). The number of STAs detected by the AP due to successful transmission of its RTS packets (106) in each contention round (104) is in the interval of [0 M] where M is equal to the MPR capacity.
c) Based on the result obtained in each contention round (104), the AP determines whether to continue or end the contention period (102) using two criteria: the threshold θ for optimal stopping or the time slot count in the AP. If the number of RTS packets (106) is equal to or greater than the threshold for optimal stopping, or the time slot counter reaches a value of zero, then the AP ends the contention period (102); otherwise, it continues.
3. During the transmission period (103):
a) If the AP determines to end the contention period (102) because it has K RTS packets (106) received, then it orders the access for the K STAs (where K belongs to the interval [1 N], where N is the number of STAs with DATA packets (109) to transmit in the network) that successfully sent their RTS packet (106) based on the duration of transmission of their DATA packets (109) from highest to lowest. Subsequently, the AP assigns, through the sending of CTS packets (107), how the channel access will be for the K STAs in groups of M. In case the time slot counter reaches zero and the AP did not receive any RTS packet (106), then the AP determines the new values of the threshold θ and CW; the latter value is sent in an ACK packet (108) to inform the new length for the CW to all STAs and start a new contention period (102).
b) The reception of the first CTS packet (107) sent by the AP serves to indicate to all the STAs that the transmission period (103) has begun. The STAs that transmitted RTS packet (106) send their DATA packets (109) if they receive permission to do so through any of the CTS packets (107) sent by the AP.
c) The AP verifies that all DATA packets (109) have been successfully received and if there are still detected STAs to transmit their DATA packets (109), then the AP initiates anew transmission round (105) by sending another CTS packet (107), instead of an ACK packet (108), to indicate which STAs are authorized to transmit their DATA packets (109).
d) The CTS packet (107) sent between transmission rounds (105) has a NACK function for the STAs that transmitted their DATA packets (109) in the last transmission round (105). That is, the CTS packet (107) tells the STAs that transmitted their DATA packets (109) that, if their address does not appear in the RA field, then it was successfully received; but if it reappears in the RA field it is because the DATA packet (109) was not received and the STA proceeds to retransmit it in the next transmission round (105).
e) When the last DATA packets (109) are transmitted in the last transmission round (105), the AP indicates the end of the transmission period (103) by sending an ACK packet (108). This packet carries the length for the CW to be used by all STAs in the next contention period (102), as well as the indication that the renewal interval (101) has ended and give the start of a new one to follow.

### B.—General Mathematical Model to Determine Traffic Carried.

For the analysis of traffic carried over the MRTC protocol, a random access WLAN based on the CSMA/CA protocol with the RTS/CTS access mechanism is assumed and simple changes at the MAC layer are considered to support the MPR capability. It is operated in a centralized scheme with K STAs and one AP, where the uplink and downlink channel are common between the STAs and the AP, as well as all can listen to each other. In addition, all STAs always have a DATA packet available for transmission, i.e., if a STA successfully transmits a DATA packet, then it immediately has another new packet to send and will compete in the next contention period (the system is in saturation). Only the AP has the MPR capacity, which is equal to M. A collision is considered to occur when more than M STAs transmit packets simultaneously. In this situation, the AP cannot receive any of the packets correctly.

In general and regardless of the MAC protocol to take advantage of the MPR capacity of the channel, the analytical expression that determines the average traffic carried on the network is given by

$${S}_{avg} = \frac{E [ {P}_{Renewal} ]}{E [ {T}_{Renewal} ]} , \qquad ( 1 )$$

where P_{Renewal} is the average data payload transmitted in a renewal interval and T_{Renewal} is the average duration of a renewal interval.

If we assume the scenario where the total number of STA K tends to infinity and the transmission probability tends to zero, then it is possible to assume that the number of transmissions in a time slot follows a Poisson distribution with parameter τ tends to zero, then it is possible to assume that the number of transmissions in a time slot follows a Poisson distribution with parameter λ=Kτ. Therefore, the probability that a number j of STAs transmit a packet in a time slot is given by

$$P \{ j STA transmiten en una ranura de tiempo \} = \frac{{λ}^{j}}{j !} {e}^{- λ} . \qquad ( 2 )$$

If M or fewer STAs transmit simultaneously, we assume that all RTS packets are correctly received by the AP during the contention round. Otherwise, a collision exists and no RTS packets are correctly received. Let be {X₁, X₁, . . . } a sequence of random variables representing the number of RTS packets successfully received by the AP in each contention round, assuming that there is at least one packet transmitted in the round. Inactive slots in a contention round are treated separately. Thus, the variables Xᵢ are assumed to be independent and identically distributed with domain 0≤Xᵢ≤M and the probability mass function is given by

$$P \{ {X}_{i} = j \} = {p}_{j} = \{ \begin{matrix}\frac{{λ}^{j}}{j ! ( {e}^{λ} - 1 )} & 1 \leq j \leq M \\ {\sum }_{k = M + 1}^{∞} \frac{{λ}^{k}}{k ! ( {e}^{λ} - 1 )} & j = 0 \\ 0 & otro caso\end{matrix} , \qquad ( 3 )$$

and the expected value is calculated as

$$E [ X ] = \frac{λ}{1 - {e}^{- λ}} {\sum }_{j = 0}^{M - 1} \frac{{λ}^{j} {e}^{- λ}}{j !} . \qquad ( 4 )$$

Assuming no propagation delay and following the framework shown in FIG. 1, the following durations are defined:

$${T}_{RTS} = RTS + DIFS , \qquad ( 5 )$$

$${T}_{C} = {N}_{C} {T}_{RTS} + {\sum }_{i = 1}^{{N}_{C}} {I}_{i} σ + CTS + 2 SIFS - DIFS , \qquad ( 6 )$$

$${T}_{ACK} = ACK + SIFS + DIFS , \qquad ( 7 )$$

$${T}_{T} = {N}_{T} ( {T}_{H} + \frac{L}{R} ) + ( {N}_{T} - 1 ) ( CTS + 2 SIFS ) + {T}_{ACK} , \qquad ( 8 )$$

where the durations of each of the times are found in the IEEE 802.11 standard. N_{C} denotes the number of contention rounds, Iᵢ denotes the number of idle slots before the RTS packet in the i-th contention round, σ is the length of an idle slot, N_{T} denotes the number of transmission rounds, T_{H} denotes the transmission time of a packet header, L is the payload length of a DATA packet, and R is the data transmission rate. It is important to mention that N_{C} is a function of λ and θ.

Since N_{C} is the number of contention rounds in a renewal interval, the total number of RTS packets successfully received at the AP, Nᵣₓ during these rounds is given by

$${N}_{rx} = {\sum }_{i = 1}^{{N}_{C}} {X}_{i} , \qquad ( 9 )$$

and represents the number of packets available for transmission in the next transmission period. But, as determined by the protocol, the number of packets that can be sent during the transmission period, Nₜₓ cannot be greater than the MPR capacity multiplied by the number of transmission rounds. N_{T} Therefore, the total number of packets transmitted in a renewal interval is given by

$${N}_{tx} = min ( {N}_{rx} , {N}_{T} M ) . \qquad ( 10 )$$

Now, the duration of a renewal interval is the sum of (6) and (8). Therefore, in bits per second is determined as (6) and (8), S_{avg} in bits per second is determined as

$${S}_{avg} = \frac{E [ {N}_{tx} \cdot L ]}{\begin{matrix}E [ {N}_{C} {T}_{RTS} + {Σ}_{i = 1}^{{N}_{C}} {I}_{i} σ + \\ {N}_{T} ( {T}_{H} + \frac{L}{R} + CTS + 2 SIFS ) + ACK + SIFS ]\end{matrix}} . \qquad ( 11 )$$

For the sum in (6) we have, by the law of iterated expected values,

$$E [ {\sum }_{i = 1}^{{N}_{C}} {I}_{i} ] = {E}_{{N}_{c}} [ {E}_{{I}_{i}} [ {\sum }_{i = 1}^{{N}_{C}} {I}_{i} \vert {N}_{c} ] ] , \qquad ( 12 )$$

where the subscript in the expected value operator represents the variable with respect to which the expected value is taken. It is important to note that the internal expected value is conditional. Since the variables Iᵢ are assumed to be independent and identically distributed, then

$$E [ {\sum }_{i = 1}^{{N}_{C}} {I}_{i} ] = {E}_{{N}_{c}} [ {N}_{C} E [ I ] ] = E [ {N}_{C} ] {m}_{I} , \qquad ( 13 )$$

where m_{I} denotes the expected value of the inactive slots preceding the RTS packet and is given by:

$${m}_{I} = E [ I ] = \frac{{e}^{- λ}}{1 - {e}^{- λ}} . \qquad ( 14 )$$

Finally, the average performance of the system is

$${S}_{avg} = \frac{\frac{E [ {N}_{tx} ]}{{N}_{T}} \cdot L}{\begin{matrix}\frac{E [ {N}_{C} ]}{{N}_{T}} ( {T}_{RTS} + {m}_{I} σ ) + \\ ( {T}_{H} + \frac{L}{R} + CTS + 2 SIFS ) + \frac{( ACK + SIFS )}{{N}_{T}}\end{matrix}} . \qquad ( 15 )$$

Therefore, the evaluation of (15) requires finding the expressions for E[N_{C}] y E[Nₜₓ]. It is important to mention that the threshold θ of the optimal stopping strategy must maximize the performance S_{avg} in (1). Having fixed the number of transmission rounds, N_{T} it is clear that θ should be at most equal to N_{T} times the MPR capacity, since this is the maximum number of packets that can be transmitted in a renewal interval. A lower value of θ will reduce the average renewal interval duration, T_{Renewal} at the expense of also reducing the average payload of transmitted data, P_{Renewal}.

### Traffic Carried Evaluation.

For the analysis of the traffic carried by the MRTC protocol, the analytical and simulated results of the invention are evaluated and compared with previous proposals that seek to take advantage of the MPR capability and show its advantages.

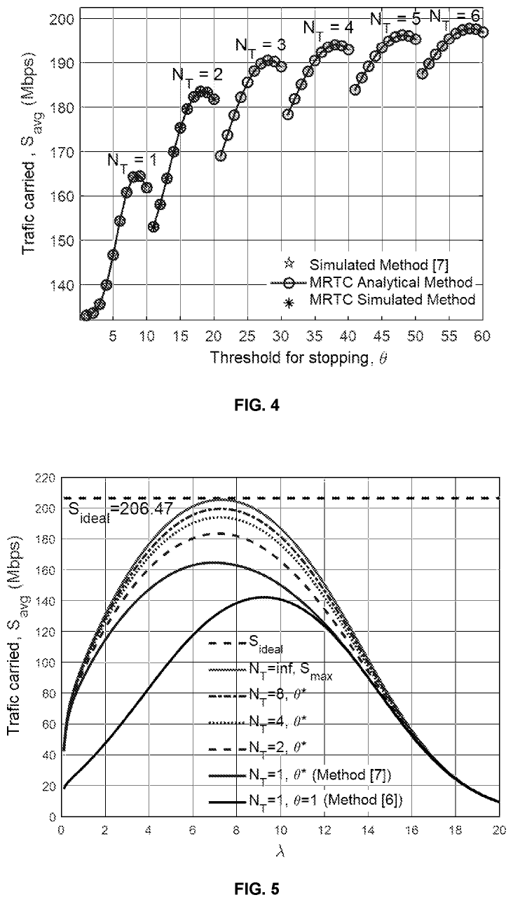

FIG. 4 shows how the analytical and simulated values of the S_{avg} as the threshold for stopping θ is increased from 1 and different values of N_{T} in a scenario where the MPR capacity is equal to 10, the traffic offered that maximizes the expected value of RTS packets received by the AP in a contention round is equal to 7.287 and a data length equal to 8184 bits at a transmission rate of 54 Mbps. When considering different values of N_{T} and, for each of these, θ takes values in the range (N_{T}−1)M+1≤θ≤N_{T}M y where the maximum throughput at S_{avg} occurs when θ is close to but below N_{T}M when N_{T}=1. At the value θ that maximizes S_{avg} for a given value of N_{T} will be referred to as the threshold for optimal stopping and will be represented by θ*. Also in the results of FIG. 4 a particular case of the MRTC protocol is demonstrated when. N_{T}=1

Table I shows the impact of increasing N_{T} on the threshold for optimal stopping θ*,

$$\frac{E [ {N}_{C} ]}{{N}_{T}} , \frac{E [ {N}_{tx} ]}{{N}_{T}} ,$$

S_{avg} and the percentage gain in S_{avg} with respect to the “Zhang” method for an MPR capacity equal to 10 and traffic offered that maximizes the expected value of RTS packets received by the AP in a contention round equal to 7.287.

TABLE I

| N_{T} | θ* | $\frac{E [ {N}_{C} ]}{{N}_{T}}$ | ${MPR}_{avg} = \frac{E [ {N}_{tx} ]}{{N}_{T}}$ | S_{avg} (Mbps) | S_{avg} porcentaje de ganancia con respecto al método [7] |
|---|---|---|---|---|---|
| 1 | 9 | 2.10 | 9.83 | 164.46 | 0 |
| 2 | 18 | 1.82 | 9.78 | 183.50 | 11.58 |
| 4 | 38 | 1.76 | 9.89 | 194.06 | 18.00 |
| 8 | 78 | 1.74 | 9.94 | 199.65 | 21.40 |
| 16 | 158 | 1.73 | 9.97 | 202.55 | 23.16 |
| 32 | 318 | 1.72 | 9.99 | 204.02 | 24.05 |

Table I, indicates how an increase of N_{T} has an effect on the reduction of

$$\frac{E [ {N}_{C} ]}{{N}_{T}}$$

and on the increase of

$$\frac{E [ {N}_{tx} ]}{{N}_{T}}$$

which are the variable parameters in equation (15) for determining the S_{avg} which is also shown. Other parameters shown in the table are the θ* and the gain that the MRTC protocol has in percentage with respect to certain values of N_{T} where it is observed that with a value of N_{T}=4 it is possible to obtain an 18% increase of the S_{avg}. All the results presented are obtained from a scenario where the MPR capacity is equal to 10, the traffic offered that maximizes the expected value of RTS packets received by the AP in a contention round is equal to 7,287 and a data length equal to 8184 bits at a transmission rate of 54 Mbps.

Table II was obtained to stablish how close to the ideal throughput of traffic carried S_{ideal} can be achieved by the S_{avg} MRTC protocols when the number of multiple transmission rounds is increased. Table II shows S_{avg} and its comparison with the ideal throughput of traffic carried S_{ideal} for MRTC protocols, “Zheng” method and “Zhang” method as the number of transmission rounds increases for an MPR capacity equal to 10 and traffic offered that maximizes the expected value of RTS packets received by the AP in a contention round equal to 7.287.

TABLE II

| | S_{avg} | Porcentaje de |
|---|---|---|
| N_{T} | (Mbps) | S_{ideal} = 206.47 Mbps |
| 1 (Método [6]) | 133.08 | 64.45 |
| 1 (Método [7]) | 164.46 | 79.65 |
| 2 | 183.50 | 88.87 |
| 4 | 194.06 | 93.99 |
| 8 | 199.65 | 96.70 |
| 16 | 202.55 | 98.10 |
| 32 | 204.02 | 98.81 |
| Sₘₐₓ (N_{T} → ∞) | 205.51 | 99.53 |

Table II S_{avg} was obtained. The scenario used in Table II is the same as the one used to obtain the results in Table I. The important results to highlight are that the method operates with the MRTC protocol using a N_{T}=4 operates at 93.99% of the S_{ideal}. In case N_{T} becomes too large (N_{T}→∞) the MRTC protocol would approximate to operate at 99.53% of the S_{ideal}.

Finally, FIG. 5 shows the behavior of the traffic carried S_{avg} with respect to the traffic offered λ of the MRTC protocol. Here the scenario used was to work with an MPR capacity equal to 10, a data length equal to 8184 bits at a transmission rate of 54 Mbps and in all cases the θ* is used for a value of N_{T}. The most important thing that can be appreciated are the different values of the traffic offered that maximizes the S_{avg} for the MRTC protocol depending on the value of N_{T} and θ*. Another result to highlight is that for low traffic offered where λ is much less than the MPR capacity, the best choice of the MRTC method is to use only one transmission round, since waiting for more contention rounds to transmit in several transmission rounds introduces more delay and in the end does not represent a considerable gain in the S_{avg}. For medium-range traffic offered, the MRTC method with N_{T}>1 represents the best option, since waiting for more contention rounds to transmit in several transmission rounds allows to obtain a larger S_{avg}. Finally, for traffic offered at saturation or too high, the MRTC method with N_{T}=1 and θ*=1 is the best option.

1. A method for performing a protocol at the 802.11. medium access control layer for leveraging multiple packet reception capability based on multiple transmission and contention rounds, wherein said method is implemented in a wireless communication system, the method characterized in that it comprises the steps of:
a) initiating a DIFS period by a transmitting node, so that when the communication channel is free since the last ACK packet transmitted, it initiates a contention period;
b) stopping the contention period initiated by the transmitting node, after a SIFS period of having transmitted a CTS packet by the transmitting node in response to having received RTS packets; and
c) sending an RTS packet, via an STA during the contention period, where the STA has a DATA packet to transmit;

2. The method according to claim 1, wherein the transmission period starts with the first transmission of the transmitting node of DATA packets and ends after a DIFS period that the transmitting node transmitted an ACK packet.

3. The method according to claim 2, wherein the STAs that successfully receive an RTS or CTS packet may have an estimate of the time that the channel will be allocated for transmission of DATA packets by means of the mechanism known as a network allocation vector.

4. The method according to claim 1, wherein the CTS and ACK packets, their formats are varied by increasing the number of receiver address fields from one up to a value M equal to the MPR capacity of the transmitting node.

5. The method according to claim 1, wherein the transmitting node decides whether or not to transmit a CTS packet after successfully receiving some RTS packets, wherein the transmitting node uses a rule to determine when transmits the CTS packet and ends the contention period.

6. The method according to claim 1, wherein the CTS packets have a second function, which is as NACK for STAs that already sent DATA packets in a transmission round and wait for the transmitting node to confirm it.

7. A wireless communication system, comprising transmitter and receiver nodes of a wireless network, wherein said wireless communication system is configured to perform a method for implementing a protocol at the 802.11 medium access control layer for leveraging multiple packet reception capability based on multiple transmission and contention rounds, wherein said comprising the steps of:
a) initiating a DIFS period by a transmitting node, so that when the communication channel is free since the last ACK packet transmitted, it initiates a contention period;
b) stopping the contention period initiated by the transmitting node, after a SIFS period of having transmitted a CTS packet by the transmitting node in response to having received RTS packets; and
c) sending an RTS packet, via an STA during the contention period, where the STA has a DATA packet to transmit;
